(19) United States
(12) Patent Application Publication
(10) Pub. No.: US 2006/0177108 A1
(43) Pub. Date: Aug. 10, 2006

(54) Method and apparatus for evaluating authentication algorithm using biometrics data

(75) Inventor: Masafumi Yashiki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/349,941

(22) Filed: Feb. 9, 2006

(30) Foreign Application Priority Data
Feb. 10, 2005 (JP) 2005-034224 (P)

(51) Int. Cl. G06K 9/00

(52) U.S. Cl. 382/115; 382/124

(57) ABSTRACT

A computer includes a database storing a plurality of pieces of identification information identifying individuals, and biometrics data particular to the individual corresponding to each of the plurality of pieces of identification information. The biometrics data is read from the database and transmitted through a communication unit. A fingerprint authentication module receives the biometrics data from the computer, and performs a comparison process of the received biometrics data in accordance with a fingerprint authentication algorithm. The data representing the result is transmitted to the computer. The computer evaluates the fingerprint authentication algorithm based on the result data and the identification information stored in the database in correspondence to the two biometrics data read and transmitted to the fingerprint authentication unit from the database for the comparison process.

This nonprovisional application is based on Japanese Patent Application No. 2005-034224 filed with the Japan Patent Office on Feb. 10, 2005, the entire contents of which are hereby incorporated by reference.

### BACKGROUND OF THE INVENTION

1. Field of the Invention

The present invention relates to method and apparatus for evaluating an authentication algorithm and, more specifically, to method and apparatus for evaluating an authentication algorithm using a computer communicating with an authentication module for authenticating an individual using the authentication algorithm.

2. Description of the Background Art

Conventionally, an authentication function attained by a personal identification number or a password has been used for identifying an individual. Such an authentication function, however, involves a number of security problems. For higher security, it is considered effective to make the identification number or password more complicated. It is difficult, however, for a person to remember a complicated identification number or a complicated password. If the identification number or the password should be known to a third party, the third party, who is not the authorized user himself/herself, is erroneously recognized as the authorized individual, as there is no measure to confirm whether the person inputting the identification number or the password is truly the person in question.

In view of the foregoing, in place of the authentication function using the identification number or password, an authentication function has been proposed in which an individual is identified by using biometrics information (biological information) particular to an individual, for example, information obtained by detecting (measuring) one's fingerprint or face. In such an authentication function, by way of example, data that can be obtained from a fingerprint image is enrolled (registered) in advance with a system, as biometrics information of the user. At the time of individual authentication for identifying an individual, the user first let the system read his/her fingerprint, to input his/her biometrics information. Then, the system compares the biometrics information of the user enrolled beforehand with the biometrics information input by the user, and identifies the user based on the result of comparison.

Authentication systems using fingerprints are disclosed, for example, in Japanese Patent Laying-Open No. 2003-058508 and Japanese Patent National Publication No. 2004-519791. These references show a configuration in which a sensor unit for reading a fingerprint and the authentication function are provided separately and the authentication function is held by a personal computer (PC), and a configuration in which the sensor unit and the authentication function are not separated but mounted on one same module.

In Japanese Patent Laying-Open No. 2003-058508, the system is formed by a PC and a biometrics information reading apparatus connected to the PC. The biometrics information enrolled in advance with the PC is compared by the PC with the biometrics information read by the biometrics information reading apparatus, and based on the result of comparison, an individual is identified. Use of the PC is allowed only when the individual is identified and successfully authenticated.

In Japanese Patent National Publication No. 2004-519791, the system is formed by a PC and a biometrics information reading apparatus connected to the PC. The biometrics information enrolled in advance with the biometrics information reading apparatus is compared by the biometrics information reading apparatus with the biometrics information read by the biometrics information reading apparatus, and an individual is identified. Access from the PC to a non-volatile memory in the biometrics reading apparatus is allowed only when the individual is identified and successfully authenticated.

The individual authentication system using biometrics information such as shown in these references have the following characteristics, as compared with the individual authentication system using an identification number or a password. Generally, when the biometrics information read by a biometrics information reading apparatus is compared with the biometrics information enrolled beforehand, the pieces of information do not perfectly match. The reason for this is that the biometrics information read by the biometrics information reading apparatus is not constant, as it depends on the health condition or characteristics of the individual. For instance, if the biometrics information is fingerprint information, the individual characteristic refer to the condition of the fingerprint, such as thin fingerprint or blurred fingerprint. In this manner, at the time of comparison, reading of the biometrics information is much influenced by disturbance. Therefore, a comparison algorithm that has a tolerance is used for comparison. Specifically, if the result of comparison of the biometrics information is within a prescribed tolerance, two pieces of biometrics information, that is, two fingerprints, are considered matching. Therefore, there is a tradeoff between convenience and security when the tolerance is determined.

As an evaluation index representing such a trade-off relation, that is, comparison accuracy of the authentication algorithm using biometrics information, False Rejection Rate (FRR) and False Acceptance Rate (FAR) are used. FRR is the rate of erroneous recognition that, though biometrics information corresponding to the read biometrics information has been enrolled in advance, the read biometrics information is recognized as not enrolled, as a result of comparison. FAR is the rate of erroneous recognition that, though biometrics information corresponding to the read biometrics information has not been enrolled, the read biometrics information is recognized as enrolled, as a result of comparison.

If FRR were lowered, FAR, representing the rate of erroneously recognizing anyone having similar biometrics information as the person of interest, would increase, undermining security. On the contrary, if FAR were lowered to heighten security, comparison would be too strict and FRR would be increased, sacrificing convenience.

In order to determine FRR and FAR as evaluation indexes representing comparison accuracy of an authentication algorithm for comparison, it is necessary to perform comparison using huge amount of biometrics information and to statistically process the result. When biometrics information is to be compared for individual authentication by a PC, the authentication algorithm for comparison is implemented as software running on the PC. In this case, it is possible to compare large amount of biometrics information by preparing a database of the biometrics information beforehand. When the authentication algorithm is to be realized on a biometrics information reading apparatus as shown in FIG. 14, generally, the following approach is adopted. Specifically, a fingerprint authentication algorithm 2 equivalent to a fingerprint authentication algorithm 5 implemented in biometrics information reading apparatus 4 using a fingerprint sensor 7 is installed as software in a PC 1 connected through communication units 3 and 6 to apparatus 4, and using the software, fingerprint authentication algorithm 5 of apparatus 4 is emulated.

Conventionally, no matter whether the authentication algorithm is installed as software in a PC or the authentication algorithm is implemented in the biometrics information reading apparatus, the authentication algorithm is implemented as software on a PC in order to determine FRR and FAR. This makes the authentication algorithm vulnerable to analysis by a third party, and the authentication procedure represented by the algorithm would easily be made open. This endangers the security of the system using the authentication algorithm.

When emulation is done, the resulting FRR and FAR come from the authentication algorithm implemented in the PC, and the authentication algorithm of the biometrics information reading apparatus is not fully the same as the authentication algorithm on the PC. Therefore, FRR and FAR obtained based on the authentication algorithm of biometrics information reading apparatus are different from FRR and FAR obtained based on the authentication algorithm of the PC, and it has been difficult to accurately determine the evaluation indexes of the authentication algorithm.

With such a background, there has been a demand for an apparatus that can evaluate an authentication algorithm of a biometrics information reading apparatus by determining FRR and FAR through comparison of large amount of biometrics information, using the authentication algorithm of the biometrics information reading apparatus.

### SUMMARY OF THE INVENTION

Therefore, an object of the present invention is to provide method and apparatus for evaluating an authentication algorithm that can easily and accurately evaluate performance of the authentication algorithm from outside, by communication with an authentication unit having the authentication algorithm using biometrics data.

In order to attain the above-described object, according to an aspect, the present invention provides an authentication algorithm evaluating apparatus communicating with an authentication unit controlling execution of the authentication algorithm comparing two biometrics data with each other and outputting comparison result, having the following configuration.

Specifically, the apparatus includes: a data storing unit storing a plurality of pieces of identification information for identifying individuals, and biometrics data particular to each of the individuals corresponding to the plurality of pieces of identification information; a data transmitting unit reading the biometrics data from the data storing unit and transmitting to the authentication unit; a result receiving unit receiving data of comparison result transmitted from the authentication unit; and an evaluating unit evaluating the authentication algorithm based on the result data and identification information stored in the data storing unit, in correspondence to the two biometrics data transmitted from the data transmitting unit for comparison of the result data received by the result receiving unit.

According to the present invention, the authentication algorithm evaluating apparatus transmits/receives the biometrics data and the comparison result to/from the authentication unit executing the authentication algorithm authenticating through comparison of biometrics data, and therefore, performance of the authentication algorithm can be evaluated without preparing and executing a program of the authentication algorithm on the authentication algorithm evaluating apparatus.

As a result, the authentication algorithm at the authentication unit remains a black box, that is, the authentication procedure can be kept secret, to the outside including the authentication algorithm evaluating apparatus, and therefore, security of the authentication using the authentication algorithm can be maintained or improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram representing a configuration of the system in accordance with an embodiment.

FIG. 2 shows a configuration of a fingerprint authentication module.

FIGS. 3A and 3B show configurations of a PC.

FIGS. 4A and 4B represent configurations of a enrollment database and a comparison database.

FIGS. 5 and 6 are flow charts representing a comparison procedure.

FIG. 7 is a flow chart representing steps of storing data in the enrollment database.

FIG. 8 is a flow chart representing steps of storing data in the comparison database.

FIG. 9 is a flow chart representing authentication procedure.

FIG. 10 shows a configuration of a comparison result database.

FIG. 11 illustrates a rule for determining file names.

FIGS. 12 and 13 show exemplary outputs of the comparison result analyzing process.

FIG. 14 shows a conventional system configuration.

### DESCRIPTION OF THE PREFERRED EMBODIMENTS

In the following, the system for evaluating an authentication algorithm in accordance with an embodiment of the present invention will be described with reference to the figures.

Here, as the biometrics information obtained by detecting (measuring) biological feature, information based on fingerprints will be described as an example. The information, however, is not limited to fingerprints and, by way of example, iris, face, hand shape, blood flow and the like may be used.

Here, as the biometrics information reading apparatus, a fingerprint reading apparatus is described. In the following, fingerprint data that are enrolled in advance in the evaluation system will be referred to as enrolled data. Further, the fingerprint data to be compared with the enrolled data will be referred to as comparison data.

(Configuration)

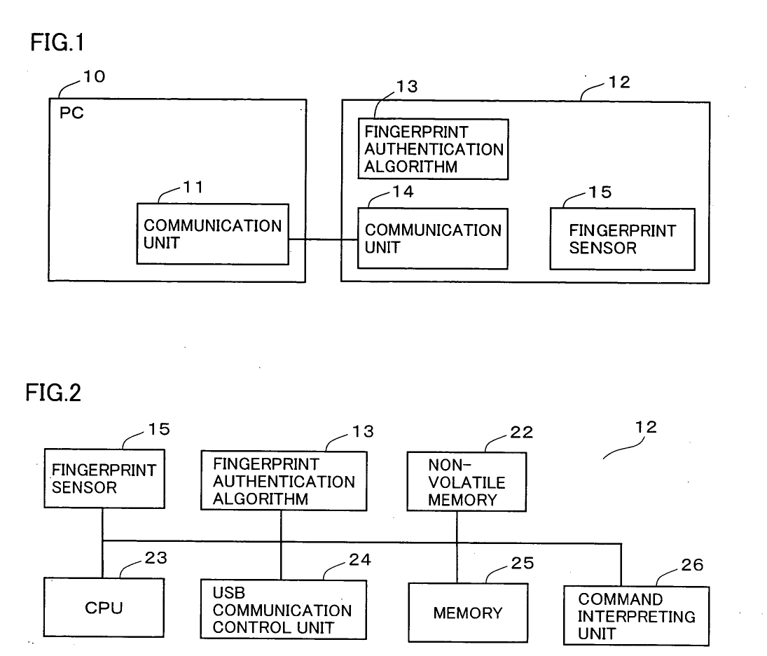

The evaluation system shown in FIG. 1 includes a PC 10 having a communication unit 11, and a fingerprint authentication module 12 having a fingerprint authentication algorithm 13, a communication unit 14 and a fingerprint sensor 15. PC 10 and fingerprint authentication module 12 communicate with each other through communication units 11 and 14 and a cable 16. Though wired communication is described here, wireless communication is also possible.

Referring to FIG. 2, fingerprint authentication module 12 includes fingerprint sensor 15, fingerprint authentication algorithm 13, a non-volatile memory 22, a CPU (Central Processing Unit) 23, a USB (Universal Serial Bus) communication control unit 24 corresponding to communication unit 14, a memory 25 including a RAM (Random Access Memory) and an ROM, and a command interpreting unit 26. These components are connected to each other through a bus. CPU 23 controls other components.

Fingerprint sensor 15 is controlled by CPU 23, reads a fingerprint image, converts the read image to digital data, and outputs the converted digital data. Fingerprint authentication algorithm 13 is an algorithm for comparing the enrolled data with the comparison data, and provided as a program stored in advance in memory 25 and executed by CPU 23, or a circuit that realizes the function of the program. Non-volatile memory 22 is a storage medium storing enrollment data that is enrolled with the system in advance. USB communication control unit 24 is controlled by CPU 23 and controls communication with PC 10, in accordance with USB standard. Memory 25 has a work area for CPU 23, and in the work area, enrollment data or comparison data is stored temporarily. Command interpreting unit 26 is controlled by CPU 23, and interprets a command received from PC 10 through USB communication control unit 24. CPU 23 controls various portions of fingerprint authentication module 12, in accordance with the result of interpretation by command interpreting unit 26 of the command received from PC 10.

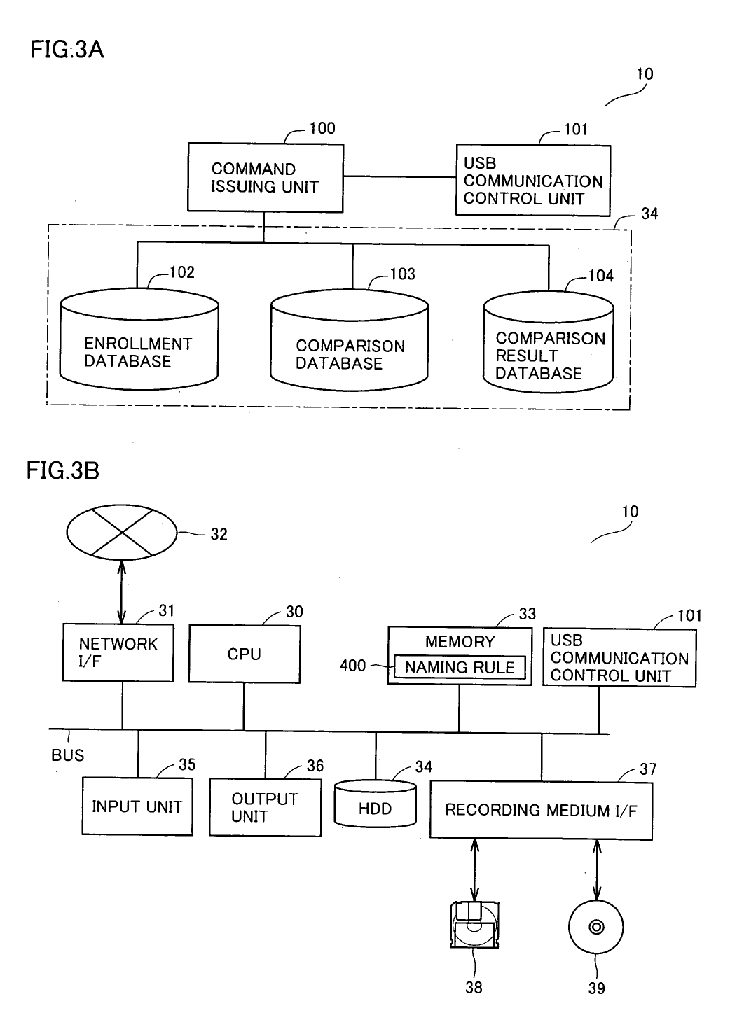

Referring to FIG. 3A, PC 10 has a command issuing unit 100, a USB communication control unit 101 corresponding to communication unit 11, enrollment database 102, comparison database 103, and a comparison result database 104.

Command issuing unit 100 generates and issues a command for controlling fingerprint authentication module 12 through USB communication control unit 101. The command is for obtaining a fingerprint image, forming enrollment data, forming comparison data, obtaining enrollment data, obtaining comparison data, starting comparison, or obtaining comparison result. USB communication control unit 101 controls, in accordance with USB standard, communication with fingerprint authentication module 12. In enrollment database 102, enrollment data to be used for evaluating fingerprint authentication algorithm 13 is stored as a file. In comparison database 103, comparison data to be used for evaluation of fingerprint authentication algorithm 13 is stored as a file. In comparison result database 104, in order to evaluate fingerprint authentication algorithm 13 performing fingerprint comparison using data stored in enrollment database 102 and comparison database 103, the result of comparison is stored.

Referring to FIG. 3B, PC 10 includes: a CPU 30; a network I/F (interface) 31 for connection to an external communication network 32; a memory 33; an HDD (Hard Disk Drive) 34 storing enrollment database 102, comparison database 103 and comparison result database 104; an input unit 35 implemented as a keyboard, a mouse or the like, operated for inputting information; an output unit 36 for displaying or printing information; a recording medium I/F 37 to which a recording medium is detachably mounted from the outside, allowing access to the mounted recording medium; and a USB communication control unit 101. The recording medium accessed by recording medium I/F 37 includes, and not limited to, an FD (Flexible Disk) 38 and a CD-ROM (Compact Disc-Read Only Memory) 39. The components shown in FIG. 3B are connected to each other through a bus, and controlled by CPU 30. In memory 33, various data including a naming rule 400, which will be described later, and programs are stored.

Here, a conventionally proposed method of fingerprint comparison is adopted as fingerprint authentication algorithm 13. To the fingerprint authentication, either one of two methods, that is, correlation matching and feature point extraction (minutiae matching) is applied. Here, it is assumed that the latter, feature point extraction method is applied.

In the feature point extraction method, attributes of bifurcations and endings of a ridge (raised portion) of a fingerprint and positional information thereof (information related to direction, distance, two-dimensional coordinates and so on) are used as feature information used for comparison. In the present embodiment, the enrollment data and the comparison data represent the feature information. Fingerprint authentication algorithm 13 compares the enrollment data with the comparison data, and when some of the feature points match between the two, the two data, that is, two fingerprints, are regarded as matching. In that case, authentication is successful. Authentication is considered successful, though not all the feature points match. The criterion for determining whether authentication is successful or not is the number of feature points that must match between the data. Therefore, authentication becomes stricter if the number of feature points to be matched is increased. Such a method is common in the field of fingerprint authentication and disclosed, for example, in Japanese Patent Laying-Open No. 2001-243465.

(As to the Database)

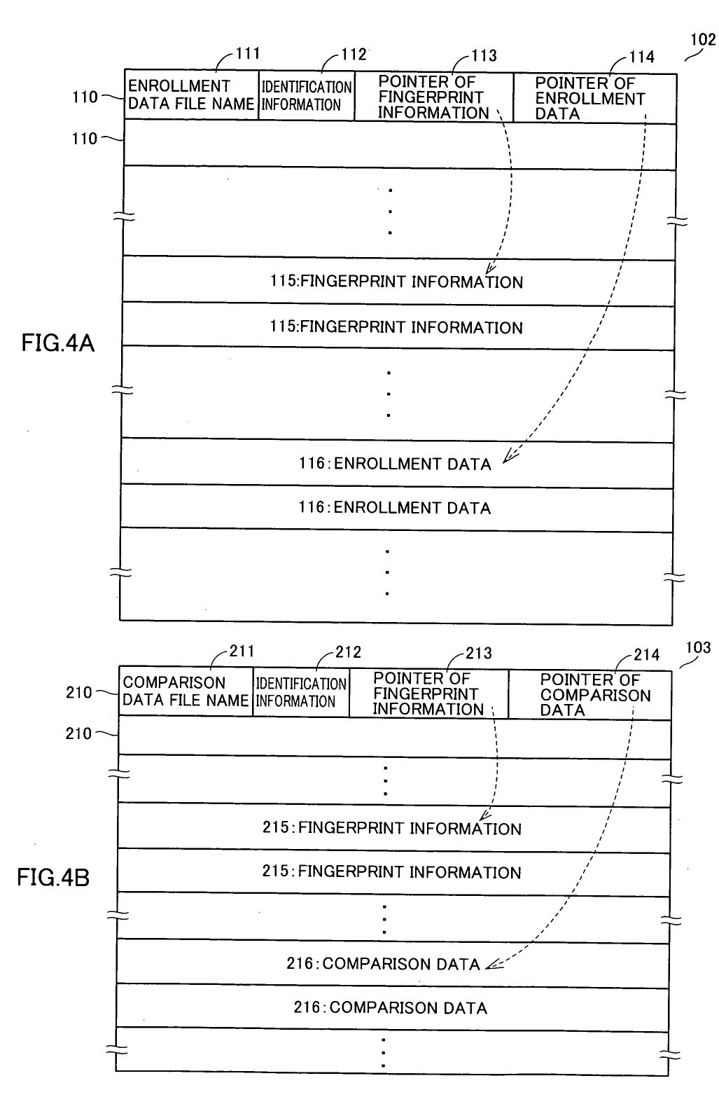

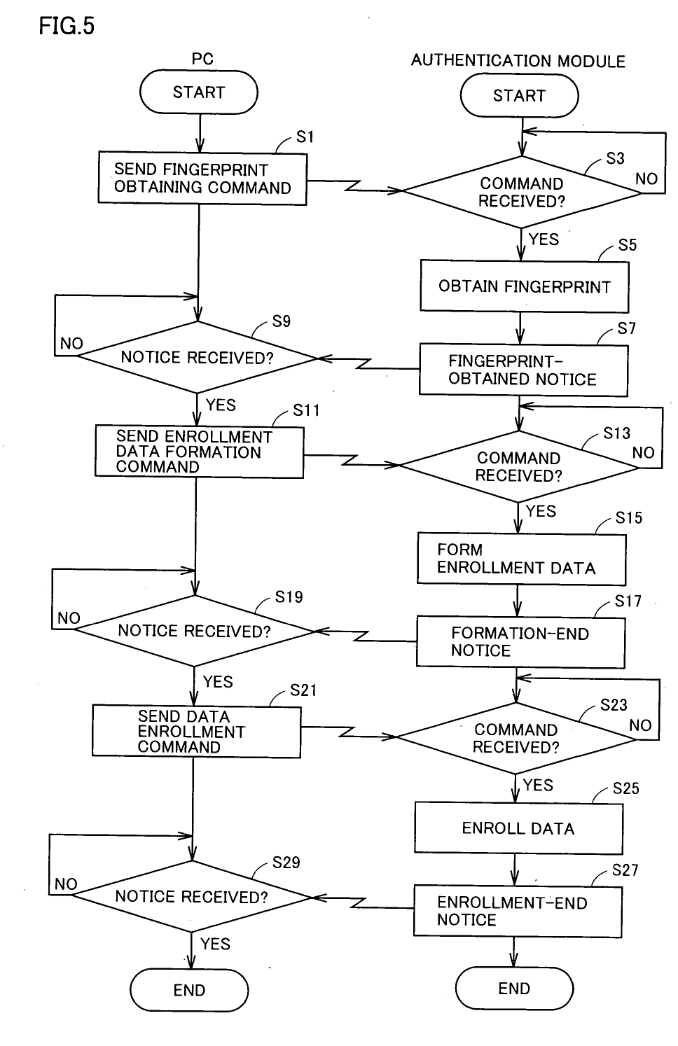

Referring to FIG. 4A, in enrollment database 102, a plurality of enrollment data 116 are stored, each as a file. Corresponding to each of the enrollment data 116 as files, a record 110 as management information of the file and fingerprint information 105 are stored. Record 110 includes data 111 representing a file name of the corresponding enrollment data 116, identification information 112 for identifyfing the enrollment data 116 of the corresponding file, a pointer 113 for the fingerprint information, and a pointer 114 for the enrollment data. Pointer 113 for the fingerprint information designates an address of fingerprint information 115 of the corresponding enrollment data 116. Pointer 114 for the enrollment data designates an address of the corresponding enrollment data 116.

Referring to FIG. 4B, in comparison database 103, a plurality of comparison data are stored, each as a file. Corresponding to each of the comparison data 216 as files, a record 210 as management information of the file and fingerprint information 215 are stored. Record 210 includes a data 211 representing file name of the corresponding comparison data 216, identification information 212 for identifying the comparison data 216 of the corresponding file, a pointer 213 for the fingerprint information, and a pointer 214 for the comparison data. The value of pointer 213 for the fingerprint information designates an address of fingerprint information 215 of the corresponding comparison data 216. The value of pointer 214 for the comparison data designates an address of the corresponding comparison data 216.

Pieces of fingerprint information 115 and 215 represent image data of fingerprints of corresponding enrollment data 116 and comparison data 216. The fingerprint images reveal features of fingerprints, such as a thin fingerprint, a blurred fingerprint and a fingerprint with abrasion.

Pieces of identification information 112 and 212 represent names of the owners of fingerprints in the corresponding enrollment data 116 and comparison data 216. The name of a fingerprint owner is input from the outside through input unit 35, at the time of obtaining the fingerprint.

In enrollment database 102, every time a enrollment data 116 is stored, the corresponding record 110 is generated, and the generated record 110 and fingerprint information 115 are stored. Similarly, in comparison database 103, every time a comparison data is stored, the corresponding record 210 is generated, and the generated record 210 and the fingerprint information 215 are stored.

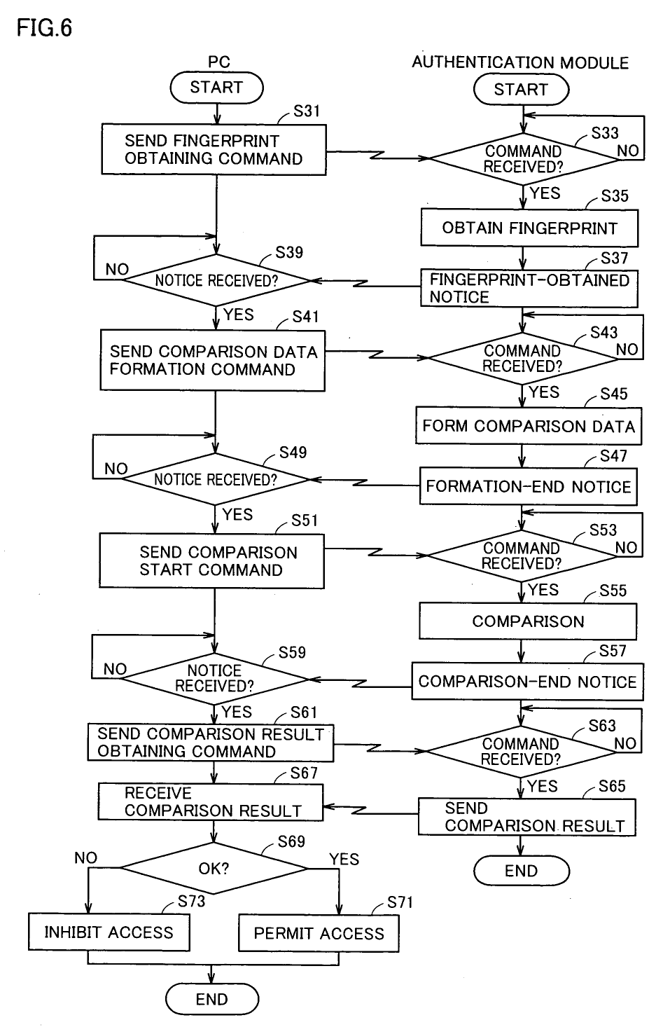

(Access Control Using Fingerprint Authentication) Referring to the flow charts of FIGS. 5 and 6, an operation for limiting access to PC 10 using fingerprint authentication module 12 will be described. FIG. 5 shows process steps for obtaining the enrollment data. It is assumed that a finger is placed on fingerprint sensor 15 and fingerprint sensor 15 is ready for obtaining the fingerprint. Referring to FIG. 5, PC 10 issues a fingerprint obtaining command using command issuing unit 100, through USB communication control unit 101 (step S (hereinafter simply denoted by “S”)1).

In fingerprint authentication module 12, when the fingerprint obtaining command is received through USB communication control unit 24 (YES in S3), the received fingerprint obtaining command is interpreted by command interpreting unit 26. Based on the interpretation, CPU 23 controls fingerprint sensor 15, the fingerprint is read by fingerprint sensor 15, the read fingerprint image is converted to digital data, and the digital data is output (S5). When the fingerprint is obtained, CPU 23 transmits or sends a fingerprint-obtained notice through USB communication control unit 24 (S7).

Receiving the fingerprint-obtained notice through USB communication control unit 101 (YES in S9), PC 10 issues a enrollment data formation command using command issuing unit 100, through USB communication control unit 101 (S11).

In fingerprint authentication module 12, when CPU 23 receives the enrollment data formation command through USB communication control unit 24 (YES in S13), the received command is interpreted by command interpreting unit 26, and based on the result of interpretation, the enrollment data is formed (S15). Specifically, the digital data output from fingerprint sensor 15 in S5 is converted to the enrollment data in memory 25. When the enrollment data is formed, CPU 23 transmits a formation-end notice through USB communication control unit 24 (S17).

Receiving the formation-end notice through USB communication control unit 101 (YES in S19), PC 10 issues a enrollment data enrolling command using command issuing unit 100 through USB communication control unit 101 (S21).

In fingerprint authentication module 12, when CPU 23 receives the enrolling command through USB communication control unit 24 (YES in S23), the received enrolling command is interpreted by command interpreting unit 26, and based on the interpretation, CPU 23 stores the enrollment data formed on memory 25 to non-volatile memory 22 (S25). Then, it transmits a enrollment-end notice through USB communication control unit 24 (S27). When the enrollment-end notice is received by PC 10 through USB communication control unit 101 (YES in S29), the series of operations ends.

Referring to the flow chart of FIG. 6, the process of comparing the enrollment data with the comparison data using fingerprint authentication module 12 will be described. It is assumed that a finger is placed on fingerprint sensor 15 and fingerprint sensor 15 is ready for obtaining the fingerprint, and that the enrollment data have been stored in non-volatile memory 22 through the steps shown in FIG. 5.

First, PC 10 issues the fingerprint obtaining command using command issuing unit 100 through USB communication control unit 101 (S31). In fingerprint authentication module 12, when the fingerprint obtaining command is received through USB communication control unit 24 (YES in S33), the received fingerprint obtaining command is interpreted by command interpreting unit 26. Based on the interpretation, CPU 23 controls fingerprint sensor 15, the fingerprint is read by fingerprint sensor 15, the read fingerprint image is converted by digital data, and the digital data is output (S35). When the fingerprint is obtained, CPU 23 transmits a fingerprint-obtained notice through USB communication control unit 24 (S37).

Receiving the fingerprint-obtained notice through USB communication control unit 101 (YES in S39), PC 10 issues a comparison data formation command using command issuing unit 100 through USB communication control unit 101 (S41).

In fingerprint authentication module 12, when CPU 23 receives the comparison data formation command through USB communication control unit 24 (YES in S43), the received command is interpreted by command interpreting unit 26, and based on the result of interpretation, the comparison data is formed (S45). Specifically, the digital data output from fingerprint sensor 15 in S35 is converted in memory 25 to the comparison data. When the comparison data is formed, CPU 23 transmits a formation-end notice through USB communication control unit 24 (S47).

Receiving the formation-end notice through USB communication control unit 101 (YES in S49), PC 10 issues a comparison start command using command issuing unit 100 through USB communication control unit 101 (S51). In fingerprint authentication module 12, when the comparison start command is received through USB communication control unit 24 (S53), the received command is interpreted by command interpreting unit 26, and CPU 23 executes a comparison process in accordance with the result of interpretation (S55). Specifically, using the fingerprint authentication algorithm 13, the enrollment data stored in non-volatile memory 22 is read, and the read enrollment data is compared with the comparison data formed in S45 in a work area of memory 25, in accordance with the process steps shown in FIG. 5. Then, CPU 23 transmits a comparison-end notice (S57).

Receiving the comparison-end notice (YES in S59), PC 10 issues a command for obtaining a comparison result using command issuing unit 100 through USB communication control unit 101 (S61). In fingerprint authentication module 12, receiving the command (YES in S63), the received command is interpreted by command interpreting unit 26, and CPU 23 transmits the result of comparison of S55 based on the result of interpretation (S65).

In PC 10, receiving the result of comparison (S67), CPU 30 analyzes the received result of comparison, and when it is determined based on the analysis that authentication has been successful (YES in S69), CPU 30 allows (accepts) an external access or operation through input unit 35, network I/F 31, USB communication control unit 101 or the like (S71). When it is determined that authentication has been unsuccessful (failed) (NO in S69), such an access or operation is inhibited (not accepted) (S73).

In this manner, based on the result of comparison between the enrollment data and the comparison data by fingerprint authentication module 12, an access to or an operation on PC 10 is permitted or inhibited.

(Data Enrollment with Database)

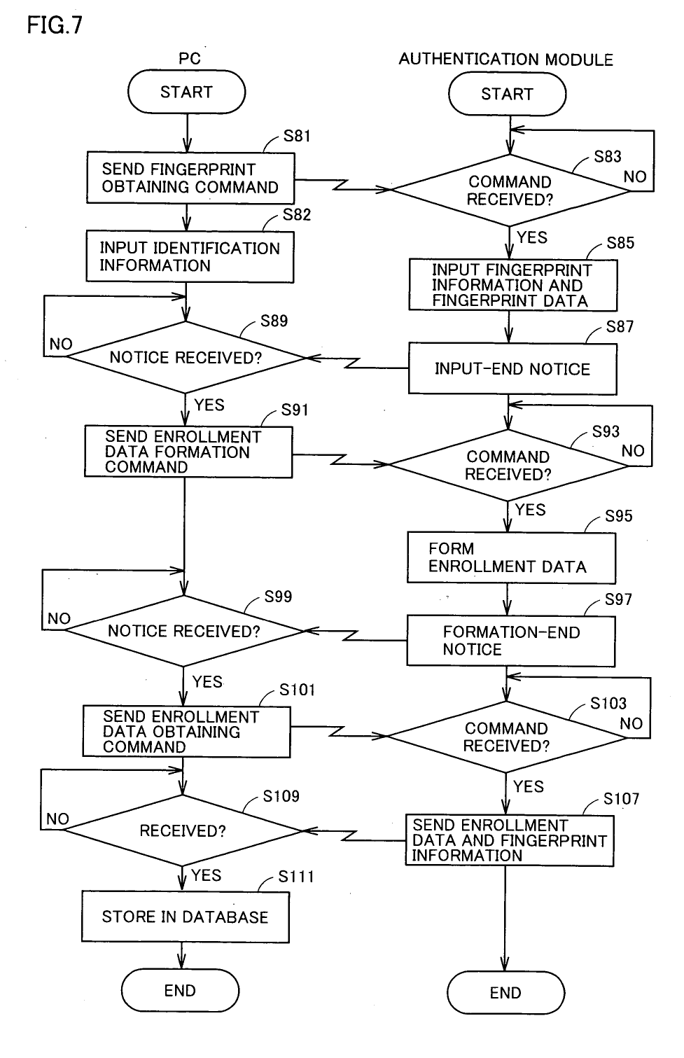

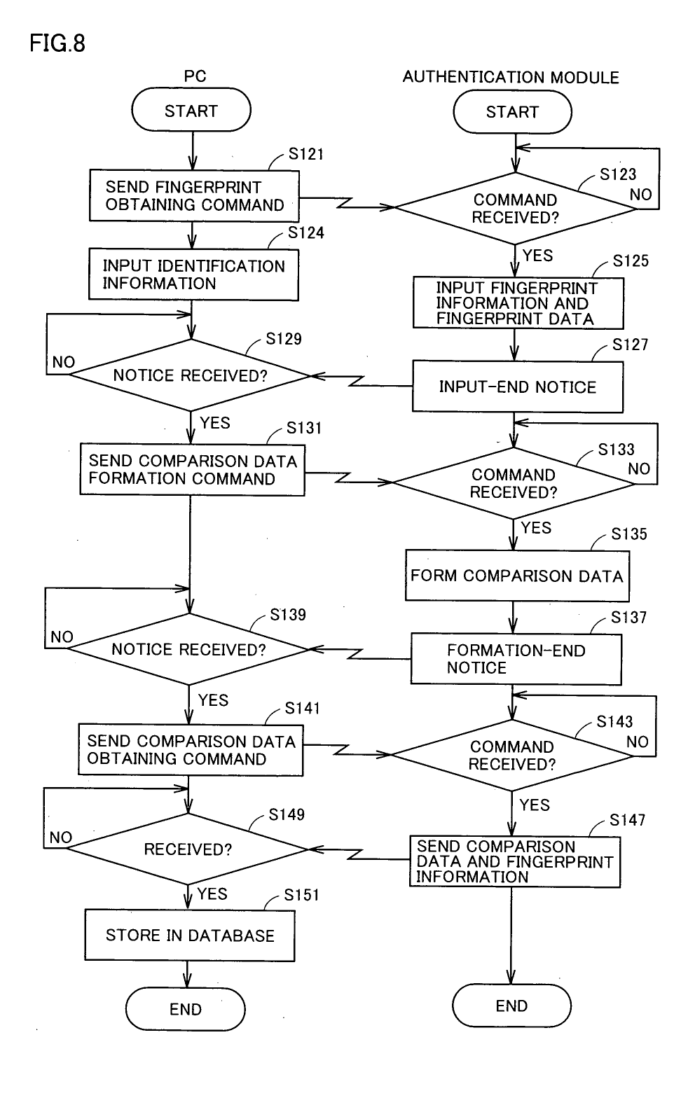

PC 10 has a plurality of operation modes, including a mode for storing data in enrollment database 102, and a mode for storing data in comparison database 103. Process steps for storing enrollment data 116 and comparison data 216 in enrollment database 102 and comparison database 103 are shown in the flow charts of FIGS. 7 and 8, respectively. Here, it is assumed that a finger is placed on fingerprint sensor 15 and fingerprint sensor 15 is ready for obtaining the fingerprint. Referring to FIG. 7, first, in order to control fingerprint authentication module 12, PC 10 issues a fingerprint obtaining command using command issuing unit 100 through USB communication control unit 101 (S81). At this time, the user inputs identification information through input unit 35 (S82). The identification information is information of the name of a person whose finger is placed on fingerprint sensor 15. Though the identification information is the name here, any information other than the name may be used, provided that the read fingerprint can be uniquely identified.

In fingerprint authentication module 12, when the fingerprint obtaining command is received through USB communication control unit 24 (YES in S83), the received command is interpreted by command interpreting unit 26, and based on the result of interpretation, CPU 23 controls fingerprint sensor 15. Fingerprint sensor 15 reads the fingerprint, converts the read fingerprint image to digital data and outputs the digital data. By the reading of fingerprint, fingerprint information is input (S85). Then, CPU 23 transmits a fingerprint data-input-end notice (S87).

Receiving the input-end notice (YES in S89), PC 10 issues a enrollment data formation command using command issuing unit 100 through USB communication control unit 101 (S91). In fingerprint authentication module 12, receiving the enrollment data formation command through USB communication control unit 24, command interpreting unit 26 interprets the received command, and based on the result of interpretation, CPU 23 converts the digital data output from fingerprint sensor 15 to enrollment data 116 (S95). Then, CPU 23 transmits a enrollment data formation-end notice (S97).

Receiving the formation-end notice (YES in S99), PC 10 issues a enrollment data obtaining command using command issuing unit 100 through USB communication control unit 101 (S101). Receiving the enrollment data obtaining command (YES in S103), CPU 23 of fingerprint authentication module 12 transmits the formed enrollment data 116 and the fingerprint information input in S85 (S107). The fingerprint information is digital data output from fingerprint sensor 15, that is, image information representing fingerprint images.

Receiving the enrollment data 116 formed in fingerprint authentication module 12 and the fingerprint information (YES in S109), PC 10 stores the received enrollment data 116 in enrollment database 102 as a file, and also stores the received fingerprint information. Thus, fingerprint information 115 is stored in enrollment database 102 (S111).

Here, storing “as a file” refers to the following procedure. Specifically, the fingerprint information and enrollment data 116 received from fingerprint authentication module 12 are once stored in memory 33 of PC 10. Then, CPU 30 forms a enrollment data file name 111 for the enrollment data 116 of memory 33. Then, enrollment data 116 and fingerprint information 115 are stored in enrollment database 102 of HDD 34, whereby CPU 30 determines values of pointers 113 and 114. Enrollment data 116 in memory 33 is binary data, and stored as it is in enrollment database 102. At this time, a record 110 is generated and stored, which record has the formed enrollment data file name 111, identification information 112 input in S82, pointer 113 for the stored fingerprint information 115 and pointer 114 for the stored enrollment data 116. The method of forming enrollment file name 111 will be described later with reference to FIG. 11. When the enrollment data 116 is stored as a file in enrollment database 102, the corresponding record 110 and fingerprint information 115 are also stored in enrollment database 102.

Referring to FIG. 8, the process steps for forming comparison database 103 will be described. As shown in FIG. 8, first, in order to control fingerprint authentication module 12, PC 10 issues a fingerprint obtaining command using command issuing unit 100 through USB communication control unit 101 (S121). At this time, the user inputs identification information through input unit 35 (S124). The identification information is the name of a person whose finger is placed on fingerprint sensor 15, as in S82.

In fingerprint authentication module 12, when the fingerprint obtaining command is received through USB communication control unit 24 (YES in S123), the received command is interpreted by command interpreting unit 26, and based on the result of interpretation, CPU 23 controls fingerprint sensor 15. Fingerprint sensor 15 reads the fingerprint, converts the read fingerprint image to digital data and outputs the digital data. By the reading of fingerprint, CPU 23 inputs the fingerprint information (S125). Then, CPU 23 transmits a fingerprint data-input-end notice (S127).

Receiving the input-end notice (YES in S129), PC 10 issues a comparison data formation command using command issuing unit 100 through USB communication control unit 101 (S131). In fingerprint authentication module 12, receiving the comparison data formation command through USB communication control unit 24 (YES in S133), command interpreting unit 26 interprets the received command, and based on the result of interpretation, CPU 23 converts the digital data output from fingerprint sensor 15 to comparison data 216 (S135). Then, CPU 23 transmits a comparison data 216 formation-end notice (S137).

Receiving the formation-end notice (YES in S139), PC 10 issues a comparison data obtaining command using command issuing unit 100 through USB communication control unit 101 (S141). Receiving the comparison data obtaining command (YES in S143), CPU 23 of fingerprint authentication module 12 transmits the comparison data 216 and the fingerprint information input in S125 (S147).

Receiving the comparison data 216 formed in fingerprint authentication module 12 and the fingerprint information (YES in S149), PC 10 stores the received comparison data 216 in comparison database 103 as a file, and also stores the received fingerprint information. Thus, fingerprint information 215 is stored in comparison database 103.

Here, storing “as a file” refers to the following procedure. Specifically, the fingerprint information 215 and comparison data 216 received from fingerprint authentication module 12 are once stored in memory 33 of PC 10. Then, CPU 30 forms a comparison data file name 211 for the comparison data 216 of memory 33. Then, comparison data 216 and fingerprint information 215 are stored in comparison database 103 of HDD 34, whereby CPU 30 determines values of pointers 213 and 214. Comparison data 216 in memory 33 is binary data, and stored as it is in comparison database 103. At this time, a record 210 is generated and additionally stored, which record has the formed comparison data file name 211, identification information 212 input in S124, pointer 213 for the stored fingerprint information 215 and pointer 214 for the stored comparison data 216. The method of forming comparison data file name 211 will be described later.

(Evaluation of Fingerprint Authentication Algorithm)

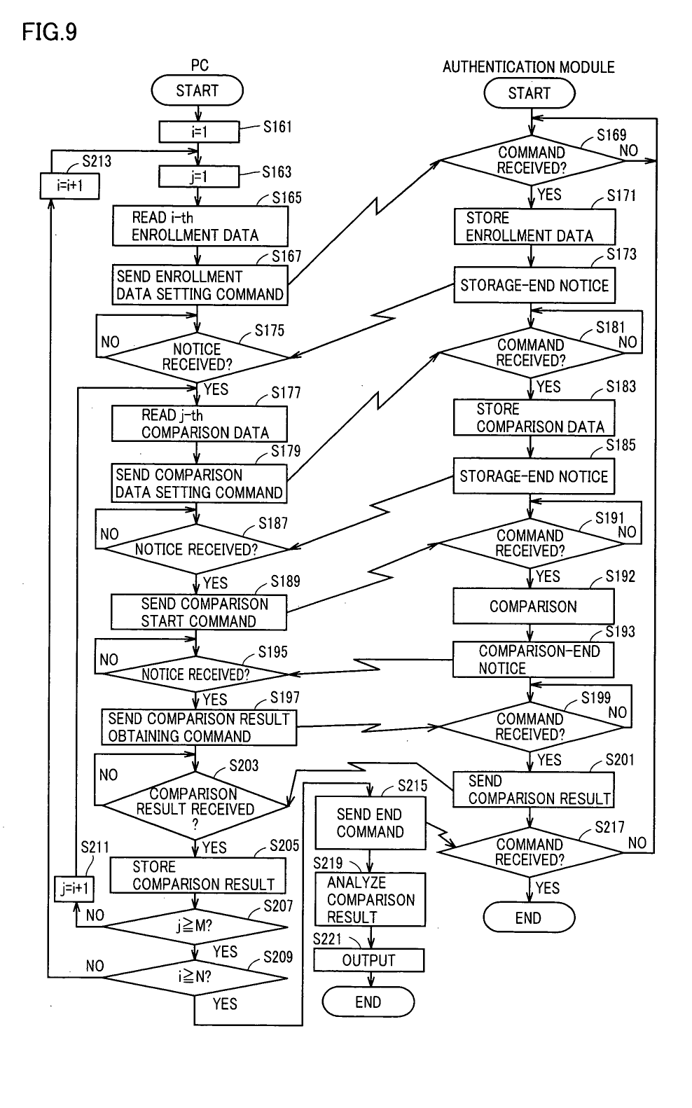

Referring to FIG. 9, process steps for authentication performed by fingerprint authentication module 12 using enrollment data 116 stored in enrollment database 102 and comparison data 216 stored in comparison database 103 will be described. Here, it is assumed that through the process steps of FIGS. 7 and 8, N (≧1) enrollment data 116 and M (≧1) comparison data 216 are stored in enrollment database 102 and comparison database 103. The variable N representing the number (N) of enrollment data and the variable M representing the number (M) of comparison data are stored beforehand in an internal memory, not shown, of CPU 30.

First, in PC 10, CPU 30 sets “1” to variables i and j for control, in an internal memory, not shown (S161, S163). The variable i is for counting enrollment data 116 read from enrollment database 102, and variable j is for counting comparison data 216 read from comparison database 103.

Thereafter, i-th enrollment data 116 is read from enrollment database 102 (S165) and, thereafter, using command issuing unit 100, a enrollment data setting command is issued, together with the read enrollment data 116, through USB communication control unit 101 (S167).

In fingerprint authentication module 12, when CPU 23 receives the enrollment data setting command through USB communication control unit 24 (YES in S169), the received command is interpreted by command interpreting unit 26. Based on the result of interpretation, CPU 23 temporarily stores the enrollment data 116 received in S169 in memory 25 (S171), and transmits a storage-end notice (S173).

Then, in PC 10, receiving the storage-end notice (YES in S175), CPU 30 reads j-th stored comparison data 216 from comparison database 103 (S177), and using command issuing unit 100, a comparison data setting command is issued, together with the read comparison data 216, through USB communication control unit 101 (S179).

In fingerprint authentication module 12, the comparison data setting command and comparison data 216 are received through USB communication control unit 24 (YES in S181), and the received command is interpreted by command interpreting unit 26. Based on the result of interpretation, CPU 23 temporarily stores the comparison data 216 received in S181 in memory 25 (S183), and transmits a storage-end notice (S185).

In PC 10, receiving the storage-end notice (YES in S187), a comparison start command is issued using command issuing unit 100 through USB communication control unit 101 (S189). In fingerprint authentication module 12, CPU 23 receives the comparison start command through USB communication control unit 24 (YES in S191). The received command is interpreted by command interpreting unit 26, and based on the result of interpretation, CPU 23 has fingerprint authentication algorithm 21 execute comparison of enrollment data 116 and comparison data 216 that are temporarily stored in memory 25 (S192). Then, the result of comparison is temporarily stored in memory 25, and a comparison-end notice is transmitted (S193).

Next, in PC 10, receiving the comparison-end notice (YES in S195), CPU 30 issues a comparison result obtaining command using command issuing unit 100 through USB communication control unit 101 (S197). In fingerprint authentication module 12, when the comparison result obtaining command is received (YES in S199), the received command is interpreted by command interpreting unit 26, and based on the result of interpretation, CPU 23 reads the comparison result from memory 25 and transmits (S201).

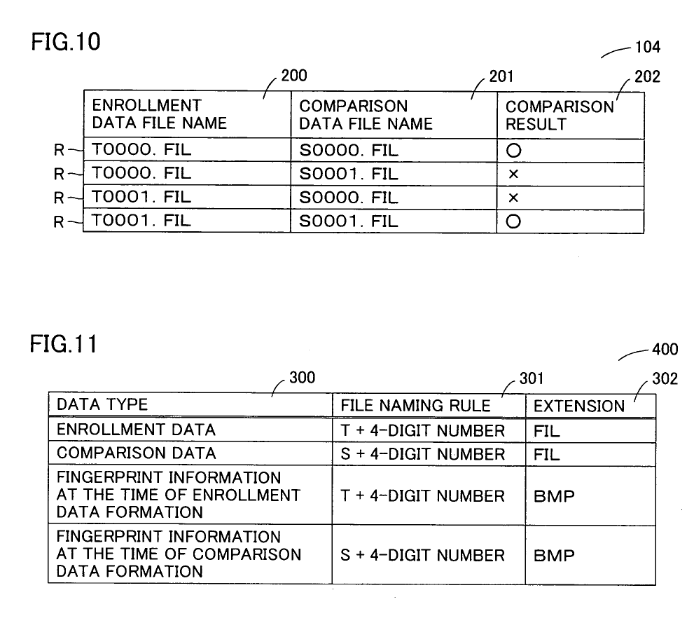

In PC 10, CPU 30 receives the comparison result from fingerprint authentication module 12 (YES in S20), and stores the received comparison result in comparison result database 104 in such a format as shown in FIG. 10, which will be described later (S205).

Thereafter, CPU 30 determines whether the value of variable j is equal to or larger than the value of variable M read from the internal memory (S207). If the value of variable j is not equal to or larger than variable M (NO in S207), the value of variable j is incremented by 1 (S211), and the flow proceeds to S177 in which the j-th comparison data 216 is read from comparison database 103. Thereafter, the process steps after S179 are executed in the similar manner as described above, on enrollment data 116 and read comparison data 216.

If the value of variable j is equal to or larger than the value of variable M (YES in S207), whether the value of variable i is equal to or larger than the value of variable N read from the internal memory or not is determined (S209). When the value of variable i is not equal to or larger than the value of variable N, the value of variable i is incremented by 1 (S213), and the value of variable j is set to 1 in the process of S163. Thereafter, the i-th enrollment data 116 is read from enrollment database 102 (S165). Thereafter, the process steps after S167 are repeated on the read enrollment data 116 in the similar manner as described above.

By repeating the process steps from S165 to S205 until the value of variable i exceeds the value of variable M and the value of variable j exceeds the value of variable N while incrementing the values of variables i and j one by one, comparison in accordance with fingerprint authentication algorithm 13 is performed on every enrollment data 116 and every comparison data 216 stored in enrollment database 102 and comparison database 103.

When comparison on every combination ends (YES in S209), a comparison end command is transmitted from PC 10 (S215). Receiving the end command (YES in S217), authentication module 12 ends the series of operations.

In PC 10, after the transmission of end command, a comparison result analyzing process is performed (S219), and the result of analysis is displayed by means of output unit 36 (S221).

Referring to FIG. 10, in comparison result database 104, every time the comparison process of S192 is executed and the comparison result is received in S197, a record R is generated and stored by CPU 30. Record R stores data 202 based on the comparison result received in S197, and data 200 and 201.

Data 202 indicates either “o” or “x”, which is determined by CPU 30. Here, “o” represents that the result of comparison between enrolled data 116 and comparison data 216 in S192 is correct, and “x” represents that the result of comparison is not correct (error).

Data 200 represents the enrollment data file name of the enrollment data 116 read in S165 used for the comparison of which result is represented by data 202 of the corresponding record R, indicated by data 111 read from enrollment database 102 by CPU 30. Data 201 represents the comparison data file name of comparison data 216 read in S177 used for the comparison of which result is represented by data 202 of the corresponding record R, indicated by data 211 read from comparison database 103 by CPU 30. The enrollment data file name and the comparison data file name are determined by the naming rule 400 that will be described later, and therefore, from the file names indicated by data 200 and 201, CPU 30 can determine whether the enrollment data 116 and the comparison data 216 of the corresponding file names come from the same fingerprint or from different fingerprints.

CPU 30 determines the value of data 202 in the following manner. When the enrollment data 116 and the comparison data 216 read in S165 and S175 (as the object of comparison) are from the same fingerprint and the result of comparison of S192 received in S197 represents a “match” of these data, the comparison result is determined to be correct, and the value of data 202 is determined to be “o”. If it represents a “mismatch”, the comparison result is determined to be erroneous, and the value of data 202 is determined to be “x”.

When the enrollment data 116 and the comparison data 216 read in S165 and S175 (as the object of comparison) are from different fingerprints and the result of comparison of S192 received in S197 represents a “match” of these data, the comparison result is determined to be erroneous, and the value of data 202 is determined to be “x”. If it represents a “mismatch”, the comparison result is determined to be correct, and the value of data 202 is determined to be “o”.

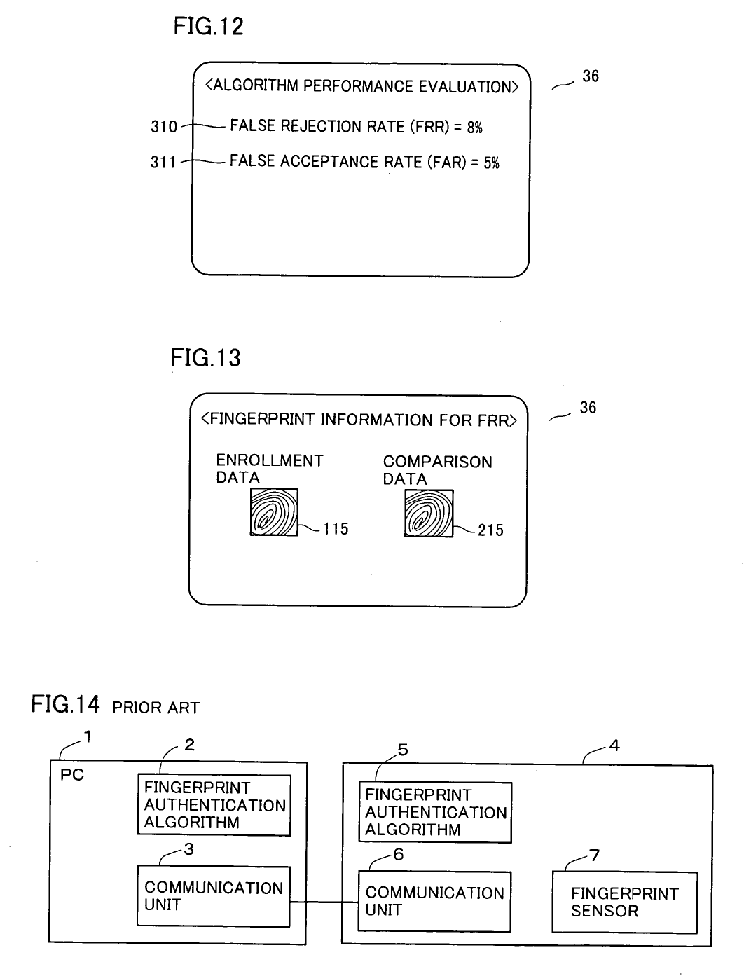

In comparison result analyzing process (S219), CPU 30 calculates FAR 311 and FRR 310. Based on the data of comparison result database 104, the ratio of the number of sets of which comparison result represented by data 202 is determined to be erroneous (x) to the total number of sets of enrollment data 116 represented by data 200 and the comparison data 216 represented by data 201 formed from the same fingerprint is calculated. This provides FRR 310. Then, the ratio of the number of sets of which comparison result represented by data 202 is determined to be correct (o) to the total number of sets of enrollment data 116 represented by data 200 and the comparison data 216 represented by data 201 formed from different fingerprints is calculated. This provides FAR 311. In S221, calculated FAR 311 and FRR 310 are displayed by output unit 36 as shown, for example, in FIG. 12.

According to the evaluation procedure described above, it is unnecessary to develop software for emulation in order to find FRR 310 and FAR 311 as evaluation indexes representing accuracy of comparison (S192) by the fingerprint authentication algorithm 13. Further, it is not the case that FRR 310 and FAR 311 are calculated by emulation on PC 10, and therefore, evaluation error derived from emulation can be avoided.

Further, as the pieces of biometrics information are provided as databases represented by enrollment database 102 and comparison database 103, the same enrollment database 102 and comparison database 103 can be shared among different authentication algorithms 13, and therefore, evaluation of different authentication algorithms 13 becomes easier.

In the method of individual authentication using biometrics information, the read biometrics information may significantly differ dependent on the shape, characteristics and circuit constants of the biometrics information reading apparatus such as fingerprint sensor 15, and the significant difference possibly affects comparison accuracy. In such a case, by connecting different fingerprint sensors 15 as biometrics information reading apparatus to one same fingerprint authentication algorithm 13, finding evaluation values of the authentication algorithm 13 for each fingerprint sensor 15 by PC 10, and by analyzing the evaluation values, it becomes possible to evaluate variations in shape, characteristics and circuit constants among the fingerprint sensors 15.

In the procedure of FIG. 9, two databases, that is, enrollment database 102 and comparison database 103 are prepared in advance and data are read from respective databases. Alternatively, the following approach may be adopted. Specifically, either one of the databases, for example, enrollment database 102 only, is used as the object database of data reading. Then, a process of reading a set of two enrollment data 116 corresponding to two different pieces of identification information 112 from enrollment database 102 and transmitting the same to authentication module 12 is performed for every such combination, and a process of transmitting a set of two enrollment data 116 obtained by consecutively reading, for every piece of identification information 112, twice the corresponding enrollment data 116 to authentication module 12 is performed for every piece of identification information 112.

(File Naming Rule)

Referring to FIG. 11, naming rule 400 for determining enrollment data file name 111 and comparison data file name 211 will be described. Naming rule 400 is stored in advance in memory 25, and therefore, CPU 30 generates (determines) the file name in accordance with naming rule 400 read from memory 25. Naming rule 400 includes, in correspondence to each of a plurality of different data types 300, a rule 301 for determining the file name and an extension 302 for the file name.

When comparison between a certain enrollment data 116 and a certain comparison data 216 is performed to find FAR and FRR, it is necessary to determine whether the data are formed from one same fingerprint or not. The determination is made based on the enrollment data file name and the comparison data file name represented by the data 111 and 211 stored in records 110 and 210 corresponding to enrollment data 116 and comparison data 216.

File names are generated in accordance with naming rule 400 in the following manner, when enrollment data 116 and comparison data 216 are stored as files in the corresponding databases. For enrollment data 116, CPU 30 generates the file name in accordance with naming rule 400, specifically, file naming rule 301 and extension 302 corresponding to the data type 300 of “enrollment data”, such that the file name starts with “T”, followed by a four-digit number and the extension “FIL”. The four-digit number is obtained by converting the identification information 112 input in S82 of FIG. 7 in accordance with a prescribed conversion rule. By way of example, enrollment file names 111 such as “T0000.FIL” and “T0001.FIL” are generated.

For comparison data 216, CPU 30 generates the file name in accordance with naming rule 400, specifically, file naming rule 301 and extension 302 corresponding to the data type 300 of “comparison data”, such that the file name starts with “S”, followed by a four-digit number and the extension “FIL”. The four-digit number is obtained by converting the identification information 212 input in S124 of FIG. 8 in accordance with a prescribed conversion rule. By way of example, comparison file names 211 such as “S0000.FIL” and “S0001.FIL” are generated.

With the enrollment data file name 111 and the comparison data file name 211 determined (generated) as described above, when comparison result data 202 is stored in comparison result database 104 of FIG. 10 in S205, it is possible for CPU 30 to determine whether the enrollment data 116 and comparison data 216 as the object of comparison come from the same fingerprint or not, based on whether the four-digit number in the enrollment data file name and the four-digit number in the comparison data file name represented by data 200 and 201 match or not.

In this manner, whether the data as the object of comparison come from the same fingerprint or not can readily be determined based on the file names, and therefore, comparison result of data 202 can be determined immediately. As a result, FRR 310 and FAR 311 can easily and quickly be calculated.

(Use of Fingerprint Information)

For evaluating fingerprint authentication algorithm 13, pieces of fingerprint information 115 and 215 that are obtained when enrollment data 116 and comparison data 215 are formed are useful. It means that by analyzing pieces of fingerprint information 115 and 215 corresponding to enrollment data 116 and comparison data 216 of which comparison result data indicates an error (x), it is possible to clarify which type of fingerprint information is well compared and which is not, by the fingerprint authentication algorithm 13. The pieces of fingerprint information 115 and 215 represent fingerprint images themselves, and from the fingerprint images, types of fingerprints such as blurred fingerprint, thin fingerprint or fingerprint with abrasion can be determined.

In steps S105 to S111, when enrollment data 116 of a fingerprint is formed and stored in enrollment database 102, fingerprint information 115 for that fingerprint is stored as a file in database 102. The file is named by CPU 30 in accordance with naming rule 400. Specifically, the file name starts with “T”, followed by a four-digit number and an extension “BMP”. The four-digit number can be obtained by converting the identification information input in S82 in accordance with the prescribed conversion rule described above. Examples of the name are “T0000.BMP” and “T0001.BMP”. Similarly, fingerprint information 115 obtained when comparison database 216 is formed is stored as a file in comparison database 103. The file is named by CPU 30 in accordance with naming rule 400. Specifically, the file name starts with “S”, followed by a four-digit number and an extension “BMP”. The four-digit number can be obtained by converting the identification information input in S124 in accordance with the prescribed conversion rule described above. Examples of the name are “S0000.BMP” and “S000l.BMP”. Thus, CPU 30 can determine that the pieces of fingerprint information come from the same fingerprint of the same person, if the four-digit numbers in the file names of fingerprint information. 115 and 215 are the same.

When the result of analysis is output in S221, CPU 30 searches and reads a record R of which data 202 is “x”, among the records R of comparison result database 104. Then, pieces of fingerprint information 115 and 215 corresponding to enrollment data 116 and comparison data 216 designated by the file names in data 200 and 201 of each read record R are read from enrollment database 102 and comparison database 103, and the read pieces of fingerprint information 115 and 215 are displayed, for example, as shown in FIG. 13, through output unit 36. The user confirms the fingerprint images derived from pieces of fingerprint information 115 and 215 displayed as shown in FIG. 13, and determines the type of the fingerprint. Specifically, the user can see that the fingerprint is blurred, shifted to the right/left or upward/downward, rotated, and so on. From such confirmation, the user can determine the tendency of the fingerprint authentication algorithm 13, that is, for what type of fingerprint image the fingerprint authentication algorithm tends to err (makes a false rejection) in authentication.

Though an example of false rejection has been described with reference to FIG. 13, similar display is given for false acceptance. Though one combination is shown in FIG. 13, combinations to be displayed may be updated successively by a prescribed key operation at the input unit 35.

(Other Examples)

The process for forming enrollment database 102 of enrollment data 116, the process for forming comparison database 103 of comparison data 216 and the process of comparison may not be executed successively, and these processes may be executed one by one independently. Once the enrollment database 102 and comparison database 103 are formed, only the comparison process shown in FIG. 9 may be performed to evaluate performance of a different fingerprint authentication algorithm 13. Therefore, by applying a plurality of fingerprint authentication algorithm 13 to the same data stored in enrollment database 102 and comparison database 103, FRR and FAR of each fingerprint authentication algorithm can be obtained, and performance of the algorithms can easily be compared with each other.

(Storage Medium)

Among the process steps shown in FIGS. 5 to 9, the process steps performed on the side of PC 10 and authentication module 12 are provided as programs, respectively. Each program is stored in a computer readable storage medium. CPU 30 or CPU 23 reads and executes each instruction (code) of the program.

In the present embodiment, as the storage medium, a medium for fingerprint authentication algorithm or memory 25 shown in FIG. 2 is used. Alternatively, the memory necessary for PC 10 to perform the process shown in FIG. 3B, such as memory 33, may itself be a program medium. A program reading apparatus such as a magnetic tape drive or a CD-ROM drive may be provided as recording medium I/F 37, and a magnetic tape or a CD-ROM 39 as a recording medium may be mounted thereon, so as to realize a readable program medium. In PC 10, the stored program may be accessed and executed by PC 30, or no matter in which recording medium the program is stored, the program may be read once, the read program is loaded to a prescribed program storage area of the apparatus shown in FIG. 3B, such as the program storage area of memory 33, and may be read and executed by CPU 30. It is assumed that the loading program is stored in advance in PC 10.

Here, the program medium described above refers to a recording medium formed detachable from the body of PC 10, and it may be a medium that fixedly carries the program, including tapes such as a magnetic tape or a cassette tape, disks such as magnetic discs, for example an FD 38 or HDD 34, or optical discs, for example, CD-ROM 39/MO (Magnetic Optical disc)/MD (Mini Disc)/DVD (Digital Versatile Disc), cards such as an IC card (including memory card)/optical card, or semiconductor memories such as mask ROM, EPROM (Erasable and Programmable Read Only Memory), EEPROM (Electrically EEPROM), flash ROM.

Further, PC 10 is adapted to have a structure that allows connection to communication network 32 including the Internet. Therefore, the program medium may be a medium that carries the program in a non-fixed manner, with the program downloaded from communication network 32. When the program is downloaded from communication network 32, the downloading program may be stored in advance in the body of PC 10, or it may be installed in advance from another recording medium to the body of PC 10.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An authentication algorithm evaluating apparatus, performing a comparison process on two biometrics data and outputting a comparison result corresponding to the comparison process, comprising:
a communication unit communicating with an authentication unit controlling execution of said authentication algorithm;
a data storage unit storing a plurality of pieces of identification information identifying individuals, and said biometrics data particular to each individual corresponding to each of said plurality of pieces of identification information;
a data transmitting unit reading said biometrics data from said data storage unit and transmitting read said biometrics data to said authentication unit through said communication unit;
a result receiving unit receiving, through said communication unit, said comparison result transmitted from said authentication unit; and
an evaluating unit evaluating said authentication algorithm based on said received comparison result and said identification information stored in said data storage unit, corresponding to said two biometrics data transmitted from said data transmitting unit for said comparison process corresponding to said comparison result received by said result receiving unit, and outputting the result of evaluation.

2. The authentication algorithm evaluating apparatus according to claim 1, wherein
said data transmitting unit includes
portion for reading and transmitting said two biometrics data corresponding to different pieces of said identification information from said data storage unit, and
portion for reading and transmitting said two biometrics data corresponding to two same pieces of said identification information from said data storage unit.

3. The authentication algorithm evaluating apparatus according to claim 1, wherein
said comparison result indicates whether said two biometrics data are matched or mismatched.

4. The authentication algorithm evaluating apparatus according to claim 3, wherein
said evaluating unit outputs said evaluation result using number of sets of which comparison result indicates a mismatch among total number of sets of said two biometrics data corresponding to said two same pieces of identification information in said data storage unit.

5. The authentication algorithm evaluating apparatus according to claim 3, wherein
said evaluating unit outputs said evaluation result using number of sets of which comparison result indicates a match among total number of sets of said two biometrics data corresponding to said two different pieces of identification information in said data storage unit.

6. The authentication algorithm evaluating apparatus according to claim 3, wherein
said biometrics data represents a feature of a fingerprint obtained from an image data of the fingerprint;
said data storage unit stores said biometrics data and image data of said fingerprint having said feature represented by the biometrics data, corresponding to each of said plurality of pieces of identification information; and
said evaluating unit reads and outputs image data of said fingerprint corresponding to each of said two biometrics data, from said data storage unit.

7. The authentication algorithm evaluating apparatus according to claim 6, wherein
said evaluating unit reads and outputs, when said evaluation result of said two biometrics data corresponding to said two same pieces of identification information represents said mismatch, image data of said fingerprints corresponding to said two biometrics data, from said data storage unit.

8. The authentication algorithm evaluating apparatus according to claim 6, wherein
said evaluating unit reads and outputs, when said evaluation result of said two biometrics data corresponding to said two different pieces of identification information represents said match, image data of said fingerprints corresponding to said two biometrics data, from said data storage unit.

9. The authentication algorithm evaluating apparatus according to claim 1, wherein
said biometrics data is stored as a file in said data storage unit; and
said identification information is indicated by a name of said file.

10. The authentication algorithm evaluating apparatus according to claim 1, wherein
said data storage unit includes a enrollment data storage unit and a comparison data storage unit;
said enrollment data storage unit stores said plurality of pieces of identification information, and said biometrics data to be enrolled in correspondence to each of said plurality of pieces of identification information;
said comparison data storage unit stores said plurality of pieces of identification information, and said biometrics data to be compared with said biometrics data to be enrolled, in correspondence to each of said plurality of pieces of identification information; and
said data transmitting unit reads said biometrics data from said enrollment data storage unit and from said comparison data storage unit, and transmits the read biometrics data to said authentication unit through said communication unit.

11. The authentication algorithm evaluating apparatus according to claim 10, having, as operation modes, a first mode in which said biometrics data is stored in said enrollment data storage unit, and a second mode in which said biometrics data is stored in said comparison data storage unit.

12. The authentication algorithm evaluating apparatus according to claim 11, wherein
said authentication unit includes
a data input unit detecting a biological feature of said individual as an object and inputting said biometrics data based on the result of detection, and
a biometrics data transmitting unit transmitting said biometrics data input by said data input unit to said authentication algorithm evaluating apparatus;
in said first mode, said authentication algorithm evaluating apparatus receives said biometrics data transmitted from said biometrics data transmitting unit of said authentication unit through said communication unit, and stores said received biometrics data in correspondence to said identification information of said individual as an object, in said enrollment data storage unit, and
in said second mode, said authentication algorithm evaluating apparatus receives said biometrics data input by said input unit and transmitted from said biometrics data transmitting unit, and stores said received biometrics data in correspondence to said identification information of said individual as said object, in said comparison data storage unit.

13. An authentication algorithm evaluating method executed by a computer communicating with an authentication unit, wherein
said authentication unit controls execution of an authentication algorithm performing a comparison process on two biometrics data and outputting a comparison result corresponding to said comparison process;
said computer includes a data storage unit storing a plurality of pieces of identification information identifying individuals, and said biometrics data particular to each individual corresponding to each of said plurality of pieces of identification information;
said authentication algorithm evaluating method comprising the steps of:
reading said biometrics data from said data storage unit and transmitting said read biometrics data to said authentication unit;
receiving said comparison result transmitted from said authentication unit; and
evaluating said authentication algorithm based on said received comparison result and said identification information stored in said data storage unit, corresponding to said two biometrics data transmitted in said transmitting step for said comparison process corresponding to said comparison result received in said result receiving step, and outputting the result of evaluation.

14. A machine readable storage device storing instructions executable by said computer to perform the method of claim 13.

15. A program product causing a computer communicating with an authentication unit to execute an authentication algorithm evaluating method, wherein
said authentication unit controls execution of an authentication algorithm performing a comparison process on two biometrics data and outputting a comparison result corresponding to said comparison process;
said computer includes a data storage unit storing a plurality of pieces of identification information identifying individuals, and said biometrics data particular to each individual corresponding to each of said plurality of pieces of identification information;
said program product comprising:
computer readable first program code means for causing said computer to read said biometrics data and to transmit said read biometrics data to said authentication unit;
computer readable second program code means for causing said computer to receive said comparison result transmitted from said authentication unit; and
computer readable third program code means-for causing said computer to evaluate said authentication algorithm based on said received comparison result and said identification information stored in said data storage unit, corresponding to said two biometrics data transmitted by said computer readable first program code means for said comparison process corresponding to said received comparison result, and to output the result of evaluation.
